(19) United States
(12) Patent Application Publication
(10) Pub. No.: US 2009/0144341 A1
(43) Pub. Date: Jun. 4, 2009

(54) Ad Hoc Data Storage Network

(75) Inventors: Jerry Hauck, Windermere, FL (US); Michael Culbert, Monte Sereno, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 11/949,645

(22) Filed: Dec. 3, 2007

(51) Int. Cl. G06F 17/30

(52) U.S. Cl. 707/202; 707/204; 707/E17.005

(57) ABSTRACT

One or more devices on a network are detected by an offsite data backup system. Upon detection of a given device, the data backup system authenticates the device and determines whether the device is authorized and capable to receive backup data. The backup system identifies data to be backed up, and one or more devices to receive the data backup, based on the combined unused storage capacity of the devices and a data backup policy that takes into account the value of the data. The data backup system can generate a database of synchronization information, which can be used to fully or partially restore data from the devices.

### TECHNICAL FIELD

The subject matter of this patent application is generally related to data backup, archiving and restoration.

### BACKGROUND

Data backup refers to the copying of data so that it can be restored after a data loss event. A data backup can restore a computer to an operational state following a disaster and restore files that are accidentally deleted or corrupted. Since a backup system typically contains at least one copy of all data worth saving, the data storage requirements can be considerable. Moreover, organizing storage space and managing the backup process can be a complicated undertaking.

One data backup solution is to subscribe to an online, offsite data backup service. Offsite backup services provide several advantages over traditional backup methods. Offsite backup services can store a data copy in a different geographic location then the original data, reducing the possibility that the original data and backup data are destroyed by the same catastrophic event (e.g., a fire or flood). Offsite backup services do not typically require user intervention, such as changing tapes, labels, compact disks (CDs) or performing other manual steps. Some offsite backup services work continuously, backing up files as they are changed. Some offsite backup services maintain a list of file versions, allowing users to select between file versions to restore.

Offsite backup services also have disadvantages. The restoration of data can be slow over public networks, such as the Internet. Because data are stored offsite, the data must be recovered either through the Internet or through a tape or disk shipped from the online backup service provider. It is also possible that an offsite backup service provider could experience downtime or go out of business, which may affect the accessibility of data. Finally, sending user data over a public network can put the data at risk if the offsite backup service has not properly secured its communication channels or its databases for storing user data.

### SUMMARY

The disadvantages described above can be overcome by the disclosed implementations of simple offsite backup of user data. One or more devices on a network (e.g., a personal computer network) are detected by an offsite data backup system. Upon detection of a given device, the data backup system authenticates the device and determines whether the device is authorized and capable to receive backup data. The backup system identifies data to be backed up, and one or more devices to receive the data backup, based on the combined unused storage capacity of the devices and a data backup policy that takes into account the value of the data. The data backup system can generate a database of synchronization information, which can be used to fully or partially restore data from the devices. Data restoration can be achieved by connecting to a single archiving device storing an application for assisting the user in restoring the data archive from additional archiving devices in the network.

In some implementations, a method includes: detecting a number of devices in a network that can store at least a portion of a data archive; determining data to be archived on the device based on a data archive policy that takes into account data value; and initiating archiving of at least a portion of the data on one or more devices in the network based on the data archive policy.

In some implementations, a method includes: initiating restoration of archived data; detecting a first device on a network; determining from the first device a number of additional devices in the network that are storing archived data; establishing connectivity with at least one additional device, if such connectivity is not already established; and restoring at least a portion of the archived data from data stored on the at least one additional device.

Other implementations of simple offsite backup of user data are disclosed, including implementations directed to systems, methods, apparatuses, computer-readable mediums and user interfaces.

### DESCRIPTION OF DRAWINGS

FIG. 1 is a block diagram of an exemplary offsite data backup system.

FIG. 2 is a flow diagram of an exemplary offsite data backup process.

FIG. 3 is a block diagram of an exemplary architecture for a data backup system.

FIG. 4 is a block diagram of an exemplary backup component shown in FIG. 3.

FIG. 5 is a screen shot of a settings dialog for a data backup system in which a general tab is selected.

FIG. 6 is a screen shot of an exemplary settings dialog in which a backup devices tab is selected.

FIG. 7 is a screen shot of an exemplary settings dialog in which a backup options button is selected.

### DETAILED DESCRIPTION

### Offsite Data Backup System Overview

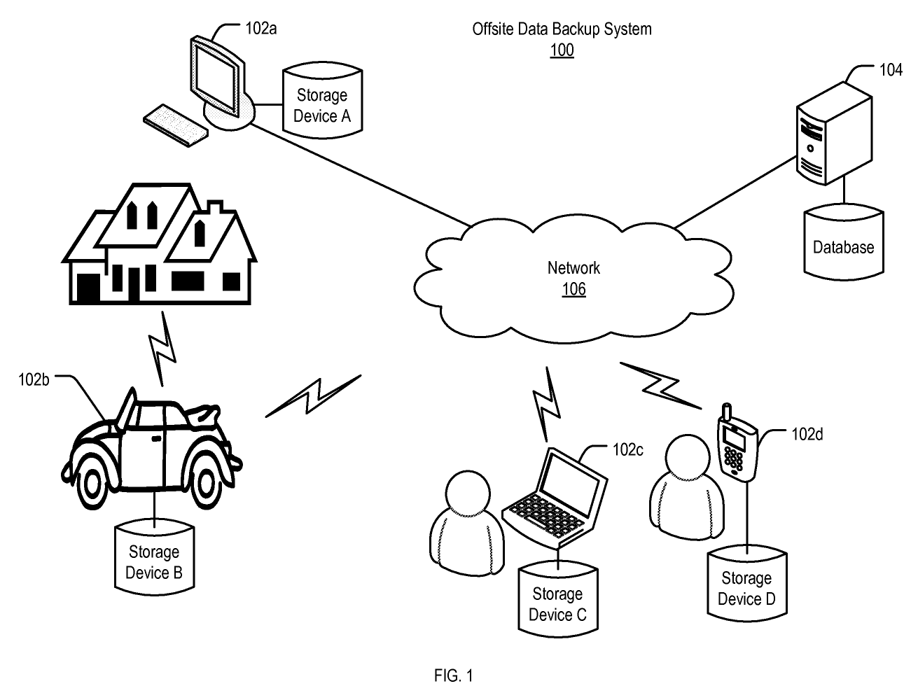

FIG. 1 is a block diagram of an exemplary offsite data backup system 100. In some implementations, the system 100 generally includes one or more physical devices 102 and an optional data backup service 104. The system 100 can be conceptualized as an ad hoc “mesh” of physical devices 102 that can play virtual roles of data creation, data archiving, or both. Each device 102 can be a “data creator” and a “data archiver.” Since the formation of connectivity between a data creator and one or more data archivers can be ad hoc, the system 100 is tolerant against frequent off-line events and/or the introduction and removal of individual data archivers. The data creator and data archivers can be logical entities and can be embodied in any physical device 102 which has the capability for connectivity to the network 106, and which possesses local and limited storage capacity that can be made available to data creators in the system 100. The configuration shown in FIG. 1 is exemplary and other configurations are possible.

A relationship between a single logical data creator and multiple logical data archivers embodied in the system 100 can be instantiated multiple times across a pool of devices 102 giving rise to the system 100. For example, a video on device 102a (e.g., a home personal computer) can be archived across a device 102b (e.g., car computer), a device 102c (e.g., portable computer) and a device 102d (e.g., a mobile phone or media player). In the example shown, the device 102a can be a data creator and a data archiver for devices 102b, 102c and 102d. Further, a controlled amount of promiscuity on the devices 102c and 102d can give rise to a concept of “social backups.” For example, when a user visits friends or relatives, the user's car, notebook computer, mobile phone, and/or media player (e.g., iPod) can become data archivers for their data creators.

In the example shown, the device 102a is a data creation device, and can be a personal computer located in a user's home or office. The device 102a can include a storage device A (e.g., a internal or external hard drive), which can store the user's data. User data includes but is not limited to various types of content (e.g., music, videos, photos, documents), software applications and any other data or information. User data can be generated by the user or purchased from a supplier.

In the example shown, the archiving devices 102b, 102c and 102d, can be any device having network connectivity and storage capability, including but not limited to: portable computers, email devices, flash drives (e.g., USB flash drive), mobile phones, media player/recorders, game consoles, personal digital assistants (PDAs), etc. Note that the data creation device 102a can be an archiving device and the archiving devices 102b, 102c and 102d can be data creation devices.

The devices 102 can be owned or operated by a single user or by different users who are part of a shared network (e.g., family members, a group of co-workers, members of a buddy list). The devices 102 can communicate through one or more networks 106 (e.g., the Internet, intranet, home/personal/private network, wireless network). As used herein, a “personal” network is a network that can be accessed by a single user or a group of authorized users, such as a home network or intranet.

In some implementations, a user may subscribe to the data backup service 104. The data backup service 104 allows a user to backup data continuously and/or on a pre-defined schedule over a public network, such as the Internet. Such services can be expensive and subject to downtime.

An advantage of the system 100 over an online backup service is the ability to utilize unused storage capacity on personal devices to avoid paying for an offsite data backup service. Some implementations of the system 100, however, include a data backup service 104 as an additional data archiver and/or as a provider of synchronization services.

In the example shown, a user stores data on a storage device A coupled to device 102a which can be a desktop computer. The user also has a storage device B in their car 102b, a storage device C in their portable laptop 102c and a storage device D in their mobile phone 102d. The storage devices A-D can be any device or media capable of storing user data (e.g., flash memory, hard disk, optical, CD ROM, DVD, RAM, ROM). The combined unused storage capacity of the storage devices B-D represents a potential storage capacity for the system 100 that is available for offsite data backup. Thus, system 100 behaves as an ad hoc distributed storage network or mesh of user devices (or a group of users), which have a combined storage capacity that fluctuates based on the number of user devices connected to the network 106, and the current unused storage capacity of each user device that is allocated for data backup.

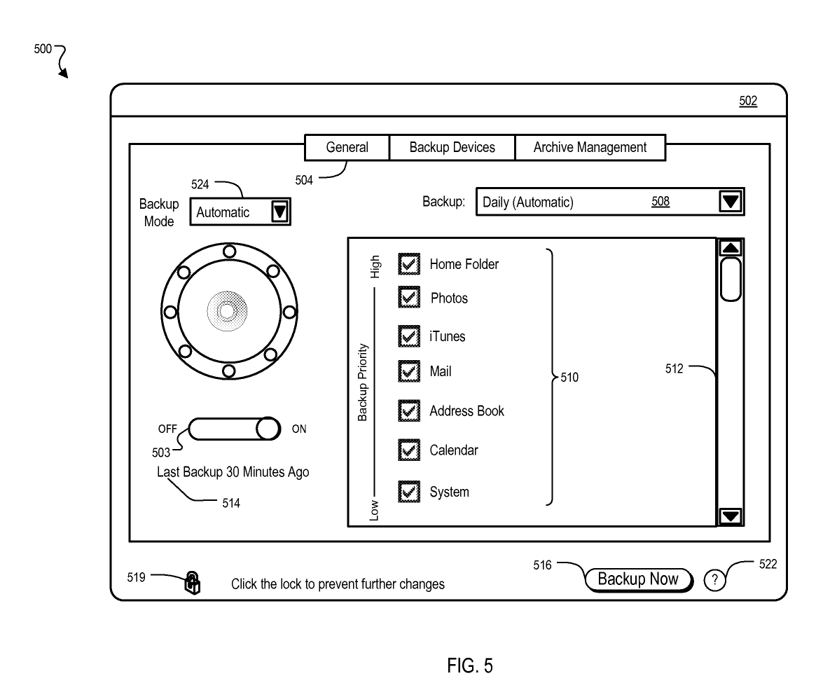

Data backup, archiving and/or restore operations can be initiated by an application or operating system running on any of the physical devices 102 and/or on a server or other device operated by the data backup service 104. For clarity purposes, a device 102 that initiates a backup or archiving operation is referred to as a “data creation” device, and a device 102 that receives data during the archiving or backup operation is referred to as “archiving” devices. For example, a user of a data creation device can manually initiate a backup or archive procedure through a user interface of an application or operating system (e.g., a utility program) installed on the data creation device. The application or operating system can detect one or more archiving devices on the network 106 in real-time. Upon detection of a given archiving device, the application or operating system can authenticate the archiving device and determine if the archiving device is authorized to receive data from the data creation device. In other implementations, data backup, archiving and restore operations can also be automatically (and transparently) initiated by a data creation device and/or an archiving device on a scheduled basis or in response to a trigger event. Examples of user interfaces for initiating data backup and restore procedures and/or for setting up manual or automatic data backups and restores are described in reference to FIGS. 5-7.

In the example shown, an application or operating system running on the data creation device 102a performs a synchronization with one or more of authenticated and authorized archiving devices 102b, 102c and 102d. The synchronization can include conflict resolution to reconcile conflicts due to changes, deletions and/or additions to user data. The archiving devices 102b, 102c and 102d, can receive encrypted user data (e.g., using RSA or PGP technology) from the data creation device 102a and/or the data backup service 104. In some implementations, the data creation device 102a and/or data backup service 104 can sign or resign files and exchange signatures with one or more of the archiving devices 102b, 102c and 102d, to facilitate authentication at the archiving devices 102b, 102c and 102d. The archiving devices 102b, 102c and 102d can include software and/or hardware for authenticating (e.g., hashing) and decrypting files.

Data backup can be performed in accordance with a data backup policy that is specified by the user through a user interface of the backup application. The policy can be used to determine which devices can be used for data backup, the type of data that can participate in data backup, the order in which data can be backed up and any other criteria related to data backup. For example, the user can specify which of the archiving devices will be used in a data backup. This feature can be useful if one or more archiving devices are not reliable for storing data and should be excluded from data backup. In some implementations, the data backup policy can specify a data backup priority list which ranks data by its value to the user, so that the most valuable user data is backed up first and/or more frequently than other user data. This feature can be useful when the combined storage capacity of storage devices B-D is not sufficient to backup all the user data targeted for backup.

The offsite data backup system 100 can provide backup redundancy for data creation devices by enabling the backup of two or more copies of data onto multiple archiving devices in addition to the backup service 104. In some implementations, the user can specify full, partial or incremental data backup. For example, the user can schedule a full data backup to occur once a month and specify an incremental data backup to occur in response to trigger events (e.g., when data is changed, added or deleted). Documents that are frequently accessed by the user or an application (e.g., determined by timestamps) may be backed up more frequently under the assumption that those files are more valuable to the user. Certain content (e.g., personal photos) may be backed up more frequently under the assumption that such content is more valuable to the user, since such content often cannot be replaced if lost or corrupted. By contrast, some data may be easily replaced and can be excluded from data backup. For example, some content, applications or data purchased by the user may be restored by downloading the content, applications or data from the original source.

The system 100 is advantageous to a user requiring data archiving by increasing the probability that the user will have access to a necessary piece of a data archive when a restore operation is requested, particularly if the archiving devices storing the data are lost, stolen, broken or replaced over time.

In some implementations, an archiving device can automatically detect and connect to a wireless network. For example, when an archiving device 102b (e.g., storage device B in the user's car) is in the proximity of a wireless network (e.g., the user's home wireless network), then an application running on the data creation device 102a can detect the archiving device 102b on the network 106 and establish a communication session. Once a communication session is established, the data creation device 102a can authenticate the archiving device 102b, determine if the archiving device 102b is authorized to receive data backup, determine the current unused storage capacity of the archiving device 102b that is allocated for data backup, and perform a data backup procedure (e.g., synchronization) in accordance with a data backup policy. Synchronization can be performed using well-known proprietary and open source synchronization technologies. Some exemplary synchronization tools include but are not limited to: iSync®, ActiveSyn®, Unison, Windows Secure Copy (WinSCP), PowerFolder, CyberDuck, iFolder, jFileSync, etc. In some implementations, synchronization services can be provided by the data backup service 104 (e.g., .MAC Sync®, Sharpcast®).

In addition to data backup, synchronizing can provide archiving devices with various types of useful information. In the example shown, a user could upload car telemetry (e.g., maps) and car maintenance information from the car navigation system (storage device B) to the personal computer in the user's home (storage device A). In another example, music files (e.g., play lists) or other content (e.g., photos, maps) can be exchanged between the car navigation system and the personal computer. Protected content can be exchanged between multiple devices and systems using known digital rights management (DRM) technology, such as Open Mobile Alliance (OMA) DRM or FairPlay® by Apple Computer, Inc. (Cupertino, Calif.).

In some implementations, archiving devices can synchronize with each other to backup data. For example, a user's mobile phone 102d (storage device D) may automatically synchronize with the user's car navigation system 102b (storage device B) to collect map data, music files or other useful information when the systems are connected to the network 106. In some implementations, a given data creation and/or one or more archiving devices can store a database of information that describes the “mesh,” including the storage capabilities of archiving devices in the “mesh” that are available for data backup, and the data types that are stored by those archiving devices. Since each data creation device knows where its data has been stored among the archiving devices in the “mesh,” each data creation device can restore its own data by synchronizing with one or more archiving devices. This information can be stored in a database or index stored on the data creation device, one or more archiving devices, or by the data backup service 104. In some implementations, the database itself can be fully or partially backed up on one or more storage devices to facilitate reconstruction of the database in the event the database is lost or corrupted. In some implementations, if a data creation device suffers a full loss of data, including the database of archiving devices, the data creation device could be introduced to a single archiving device. Based on the database of archiving devices stored on the archiving device, the data creation device could recreate all of its data from multiple archiving devices.

Connectivity between data creation and archiving devices 102 in the “mesh” can be physical (e.g., USB or FireWire®) or wireless. Wireless connectivity can be made through a Wireless Local Area Network (WLAN), such as Wi-Fi® or Bluetooth® or a cellular network using a Wireless Wide Area Network (WWAN) adapter and various well-known cellular network technologies (e.g., GPRS, CDMA2000, GSM).

The offsite data backup system 100 described above provides all the benefits of an offsite data backup service but without the associated costs. If a catastrophic event occurs at the user's home or office (e.g., a fire or flood), destroying a particular data creation device, the user can be reassured that their data is safely backed up on one or more archiving devices, such as the user's car, mobile phone, media player/recorder, etc. Moreover, the system 100 can utilize, but is not dependent on the availability of, the offsite data backup service 104.

### Offsite Data Backup Process

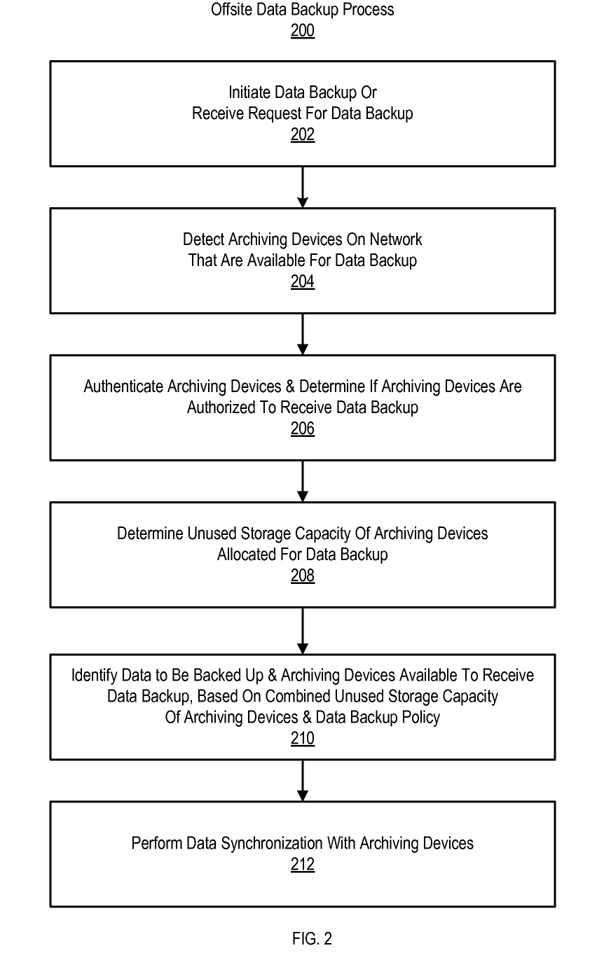

FIG. 2 is a flow diagram of an exemplary offsite data backup process 200. The process 200 steps can be implemented serially or in parallel and do not have to occur in the order shown. The process 200 begins when a data backup is initiated by a user or programmatically by an application running on a data creation device (202). The process 200 detects archiving devices on a network that are available to receive data backup (204). For example, an application running on a personal computer in the user's home or office may continuously monitor a wireless network for archiving devices 102. If an archiving device is detected, a backup application can authenticate the archiving device and determine if the archiving device is authorized to receive data backup (206). Authentication can be performed using known authentication technologies (e.g., public-key cryptography, PGP Web of Trust, MD5).

Authorization can be performed by examining the data backup policy specified by the user. For example, an archiving device may be authenticated, but not authorized, to backup data due to, for example, reliability issues (e.g., device is often down, low memory). Once a given archiving device is authenticated and authorized, then the application can determine the unused storage capacity of the archiving device that is allocated for data backup (208). Such information can be obtained through, for example, a request to a file system, operating system (OS), driver or the like, running on the archiving device. In some implementations, the archiving device may restrict the amount of storage capacity allocated for backup to ensure there is sufficient storage capacity to operate applications and store data. For example, if the archiving device is a “smart” phone, then the OS for the phone may reserve storage capacity to run communication applications.

Once the backup application has identified and authenticated one or more archiving device(s) that are available for data backup, the backup application identifies the data to be backed up and the archiving device(s) that will receive the data backup based on the combined unused storage capacity of the archiving device(s) in the “mesh” and a data backup policy (210). The data backup policy can be manually specified by the user or determined automatically by the backup application by, for example, monitoring the user's interaction with the data. The backup application data synchronizes or otherwise communicates with the archiving device(s) to backup the data (212).

Once the data is safely archived it can be restored by any device in the network. Even if the data is archived on multiple archiving devices in the network. A user need only connect with a single archive device in the network to initiate restoration or reconstruction of an archive database. In some implementations, this can be achieved by storing a copy of a management database redundantly across some or all of the archiving devices in the network. In some implementations, a method for restoring archived data includes: initiating a restoration of a data archive; detecting a first archiving device on a network; determining from the first archive device a number of additional archiving devices in the network that are storing at least a portion of the archived data; establishing connectivity (if not already established) with at least one additional archiving device; and restoring at least a portion of the archived data from data stored on the additional archiving device.

In some implementations, the data to be archived is stored redundantly across multiple archiving devices in the network to increase the chance of having access to a necessary piece of the archive when a restore operation is required. That is, not all archiving devices have to be online for a successful restoration. Redundant Array of Independent Drives (RAID) technology or similar storage technology can be used to implement redundancy across multiple archiving devices.

In some implementations, if an archiving device is missing from the network for too long (e.g., no network connectivity detected for x days), the archiving device can be revoked as a candidate for receiving data archives, causing any data archives stored on the missing archiving device to be redistributed across the remaining archiving devices in the network.

In some implementations, a single data archiving device can receive data archives from multiple creator devices (which can also be archiving devices). For example, a user's media player song database can be archived to a single archiving device, as well as data of the user's friends, family and other individuals as the user opportunistically connects with their personal networks.

In some implementations, the detection, archiving and restoration steps described above can be performed in accordance with known protocols for ad hoc or mesh networks (e.g., IEEE 802.11s). In such networks, the storage devices can be labeled as Mesh Points (MP). The MPs can form mesh links with one another, over which mesh paths can be established using a routing protocol, such as Hybrid Wireless Mesh Protocol (HWMP) or other suitable routing protocol.

### Offsite Data Backup Device Architecture

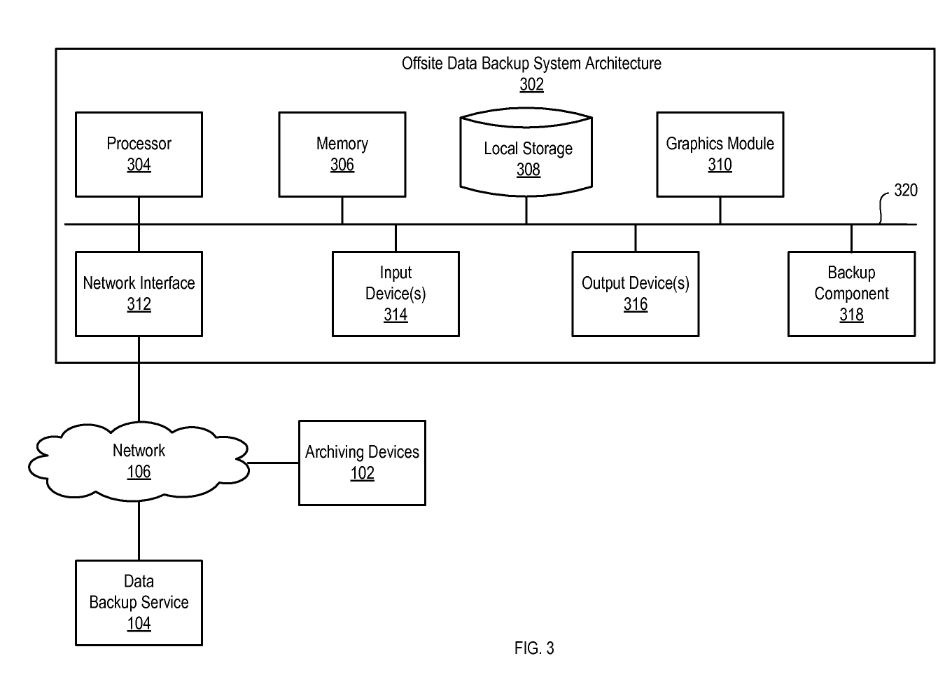

FIG. 3 is a block diagram of an exemplary architecture 302 for a data creation and data archiving device, such as the physical devices 102 shown in FIG. 1. In some implementations, the architecture 302 generally includes one or more processors 304, memory 306 (e.g., flash memory, RAM, ROM), local storage 308 (e.g., hard disk, optical disk, CD-ROM), graphics module 310 (e.g., graphics card), network interface 312 (e.g., Ethernet card, WWAN adapter, USB port), one or more input devices 314 (e.g., mouse, keyboard), one or more output devices 316 (e.g., display device) and a backup component 318. Each of these elements can be operatively coupled to one or more buses 320 for transferring and receiving instructions, addresses, data and control signals.

In some implementations, the architecture 302 can be communicatively coupled to a data backup service 104 and one or more archiving devices through a network 106 (e.g., local area network, personal/private network, wireless network, Internet, intranet) and the network interface 312. A user interacts with the architecture 302 using input devices 314 and output devices 316. The architecture 302 can include hardware, software and combinations of the two.

In some implementations, the local storage device 308 is a computer-readable medium. The term “computer-readable medium” refers to any medium that includes data and/or participates in providing instructions to a processor for execution, including without limitation, non-volatile media (e.g., optical or magnetic disks), volatile media (e.g., memory) and transmission media. Transmission media includes, without limitation, coaxial cables, copper wire, fiber optics, and computer buses. Transmission media can also take the form of acoustic, light or radio frequency waves.

### Backup Component

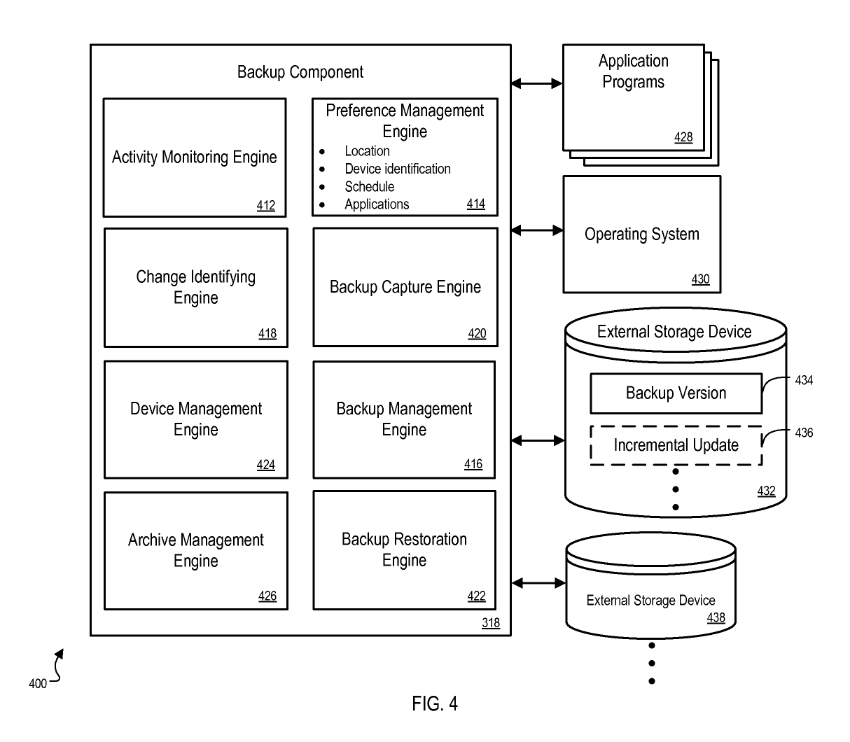

FIG. 4 is a block diagram of the exemplary backup component 318 shown in FIG. 3. The backup component 318 allows for data backup and restoration of files, content or other items to the local storage 308, an external storage repository and/or one or more archiving devices detected on the network 106 (FIG. 1).

In some implementations, the backup component 318 includes activity monitoring engine 412, preference management engine 414, backup management engine 416, change identifying engine 418, backup capture engine 420, backup restoration engine 422, device management engine 424 and archive management engine 426.

Many different data and items can be targeted for backup by the backup component 318. For example, folders, files, items, information portions, directories, images, system or application parameters, playlists, e-mail, inbox, application data, address book, preferences, a state of an application or state of the system, preferences (e.g., user or system preferences), and the like all can be targets for backup. In the example shown, the backup component 318 includes external storage device 432 and 438. Multiple versions of data can be stored on the devices 432 and 438. Any number of local and/or external storage devices can be used by the backup component 318 for storing versions. In some implementations, the backup component 318 is run as a transparent background process by an OS 430. The backup component 318 can run across multiple user accounts in a multi-user environment. The backup component 318 can also run on multiple computing platforms using multiple processors. For example, the backup component can be run on data creation and/or archiving devices 102 in the system 100, as described in reference to FIGS. 1-3.

### Activity Monitoring Engine

The activity monitoring engine 412 monitors for changes within files or other items targeted for backup. A change can also include the addition of new files or data or the deletion of same. In some implementations, the activity monitoring engine 412 can distinguish between a substantive change (e.g., modified text within a document) and a non-substantive change (e.g., the play count within an iTunes® playlist has been updated or several changes cancel each other out) through its interaction with application programs 428. The activity monitoring engine 412 can, for example, create a list of modified elements to be used when a backup event is eventually triggered. In some implementations, the activity monitoring engine 412 can monitor for periods of inactivity. The activity monitoring engine 412 can then trigger a backup event during a period of time in which the backup operation will not cause a system slowdown for an active user.

### Preference Management Engine

The preference management engine 414 specifies some operating parameters of the backup component 318. In some implementations, the preference management engine 414 contains user-specified and/or system default application parameters for the backup component 318. These parameters can include settings for the details of capturing and storing multiple backup versions. For example, the preference management engine 414 can determine the frequency of a backup capture, the storage location for backup versions, the types of files, data, or other items that are eligible for backup capture, and the events which trigger a backup capture (e.g., periodic or event-driven, etc.).

In some implementations, the preference management engine 414 can detect that a new storage device is being added to the system (e.g., through a wireless network) and prompt the user whether it should be included as a backup repository. Files and other items can be scheduled for a backup operation due to location (e.g., everything on the C: drive and within the folder D:/photos), a correlation with specific applications (e.g., all pictures, music, e-mail, address book and system settings), or a combination of backup strategies embodied in a backup policy. Different types of items can be scheduled to be stored on different devices or on different segments of a storage device during a backup operation. In some implementations, the backup component 318 stores the versions in a format corresponding to a file system structure.

### Backup Management Engine

The backup management engine 416 coordinates the collection, storage, and retrieval of backup versions of files, data, or other items, performed by the backup component 318. For example, the backup management engine 416 can trigger the activity monitoring engine 412 to watch for activities that satisfy a requirement specified in the preference management engine 414.

### Change Identifying Engine

The change identifying engine 418 locates specific user items to determine if the items have changed. In some implementations, the change identifying engine 418 can distinguish a substantive change from a non-substantive change, similar to the example described above for the activity monitoring engine 412. In some implementations, the change identifying engine 418 traverses a target set of files, data, or other items, comparing a previous version to the current version to determine whether or not a modification has occurred (e.g., by comparing hashes/fingerprints).

### Backup Capture Engine

The backup capture engine 420 locates files, data, or other items targeted for backup. The backup capture engine 420 can invoke the activity monitoring engine 412 and/or the change identifying engine 418 to generate a capture list. The backup capture engine 420 can then store copies of the items on the capture list in one or more target storage repositories (e.g., archiving devices). The backup capture engine 420 can track multiple version copies of each item included in the backup repository.

### Backup Restoration Engine

The backup component 318 includes a backup restoration engine 422 to restore versions of files, data, or other items. In some implementations, the backup restoration engine 422 provides a user interface (e.g., a graphical user interface) where a user can select item(s) to be restored.

### Device Management Engine

The device management engine 424 handles the addition and removal of individual storage devices to be used for archiving items. In some implementations, the preference management engine 414 obtains user settings regarding the identification of individual storage devices for use in archiving. These settings could include, but are not limited to, particular segments of individual devices to use, a threshold capacity which can be filled with archive data, and individual applications to archive to each device. The device management engine 424 records the storage device settings obtained by the preference management engine 414 and uses them to monitor storage device activity. In some implementations, the device management engine 424 can alert the user when a new device has been added to the system 100. In some implementations, the device management engine 424 can alert the user when an archive-enabled device has been removed from the system 100. In yet another implementation, the device management engine 424 can alert the user when an archive-enabled device is nearing its threshold storage capacity setting.

### Archive Management Engine

The archive management engine 426 tracks where archived items are being stored. In some implementations, the archive management engine 426 obtains user options from the preference management engine 414. Such settings can include, but are not limited to, methods to be used to remove older or otherwise unnecessary archived items. These settings can establish a criteria for archived item deletion, for instance in the event of storage capacity being reached or on a regular basis. In some implementations, the archive management engine 426 alerts the user when archives are missing because a device has gone offline. In some implementations, the archive management engine 426 bars a user from viewing another user's archive data due to system permissions settings.

In some implementations, the external storage device 432 can be used by the backup component 318 for archiving. In the example shown, the storage device 432 contains an initial backup version 434 and an incremental update 436. In some implementations, the incremental update 436 contains links back to data stored within the initial backup version 434, such that only one copy of an unchanged piece of data is retained. In this manner, links can also exist between incremental updates. Each incremental update can then contain a copy of each new or changed data item plus a link back to a previously stored copy of each unchanged data item. Any number of incremental updates can exist. If the user changes the scope of data that is being backed up from one incremental update period to another so that the scope of data now includes new data areas, a portion of an incremental update can be considered similar to an initial backup version. Other archive management techniques could also be used.

In some implementations, the external storage devices 432 and 433 are archiving devices which can be accessed through a network, such as network 106 of system 100 shown in FIG. 1. Thus, external storage devices can be local to a data creation device (e.g., external hard drive, USB flash drive, home network storage), or one or more archiving devices accessible through an ad hoc network.

Any number of storage devices can be used by the backup component 318. For example, a second external storage device 438 can be used as an overflow repository in the event that the first storage device 432 reaches its capacity. In another implementation, different storage devices can contain the backup version and incremental updates of data belonging to different applications or to different users of a system. As another example, two or more storage devices can be responsible for backing up contents from separate applications on the system 100.

In some implementations, backup or archive copies can be compressed and/or encrypted. An example of a compression technique is the ZIP file format for data compression and archiving. An example of an encryption technique is the RSA algorithm for public-key encryption. Other compression techniques and/or encryption techniques can also be used (e.g., AES, PGP, JPEG, MPEG).

In some implementations, if multiple users make use of the backup component 318 on a single system, each user can select to keep separate archives. Access to an individual user's archives can be password protected or otherwise held in a secure manner. In some implementations, the archive storage structure mimics a typical file system structure, such that the archived versions can be perused using a standard file system viewing utility.

### Settings Dialog—General Tab

FIG. 5 is a screen shot 500 of a settings dialog 502 for a data backup system in which a general tab 504 is selected. In some implementations, the dialog 502 is generated by the preference management engine 414 (FIG. 4). A drop-down menu 508 can be used to set the frequency of making backups (e.g. every day, every week, every other week, or every month, etc.). In some implementations, a time of day or other granularity setting could be available. Such a setting would allow the user to request that the utility run during a typically inactive period, such as overnight. In some implementations, an event-driven trigger can be specified, such as to have the backup utility run upon system start-up. In another example, a data backup can be initiated when there has been activity relating to the item to be backed up. This information can be obtained from the activity monitoring engine 412 (FIG. 4). In some implementations, a backup operation can be set to run in periods of inactivity when there is less user demand on system performance.

In some implementations, a user can select from a set of applications 510 which type(s) of data is eligible for a backup. The applications list could contain specific products (e.g. iTunes®) and/or general categories (e.g. photos, address book, e-mail inbox). In some implementations, each application name is individually selectable. For example, within an Internet browser application, the user can set the bookmarks and personal settings to be backed up but not the history or cookies. In some implementations, a user can select specific disk drives, folders, and/or files for a backup. A scroll bar 512 allows the user to view additional applications or candidates which do not fit within the viewing window. In some implementations, all data is included in the backup unless specifically excluded by the user.

In some implementations, a message block 514 alerts the user as to the date and time of the last backup event. This information can be obtained from the backup capture engine 420 (FIG. 4). The user can select a slide bar control 503 to switch the backup operations on or off. A user can select a backup now button 516 to trigger a backup event. In some implementations, the backup now button 516 calls the backup capture engine 420 (FIG. 4) to initiate a capture event using the settings provided within the settings dialog 502.

In some implementations, if a lock icon 519 is selected, the backup configuration is essentially locked into place until the icon 519 is selected again. For example, selecting the lock icon 519 in the settings dialog 502 can ensure that daily (automatic) backup operations are performed using the selected backup device (e.g., storage device B) as the storage medium until the lock icon 519 is again selected, thus unlocking the current backup configuration.

In some implementations, a user can select a help button 522 to open a help dialog to receive backup instructions. The help dialog can be presented within the settings dialog 502 or in a separate pop-up window. In some implementations, a mouse over of individual controls within the settings dialog 502 can provide the user with a brief description of that control's functionality.

In some implementations, a drop-down menu 524 allows a user to select an automatic mode for automatically specifying an order in which applications 510 are to be backed up. In some implementations, the activity monitor engine 412 (FIG. 4) can provide information that can be used to identify which data is most important to a user for determining backup order.

A variety of criteria can be used for identifying valuable data. For example, digital photos can be deemed important since such content typically is valuable to a user. A user's photos may have varying degrees of importance. Photos that are frequently accessed or placed into electronic photo albums may have more value to the user than other photos. In some implementations, photos that are deemed valuable by the system can be backed up in a high resolution format, while less important photos can be backed up in a low resolution format. By contrast, data that can be restored by other sources, such as purchased software applications may have low value to a user. In another example, a value can be placed on files based on extensions or timestamps. For example, power point or keynote presentations, tax documents, and spreadsheet documents could have high value to the user. Such documents can be identified by their extensions or properties.

### Settings Dialog—Backup Device Tab

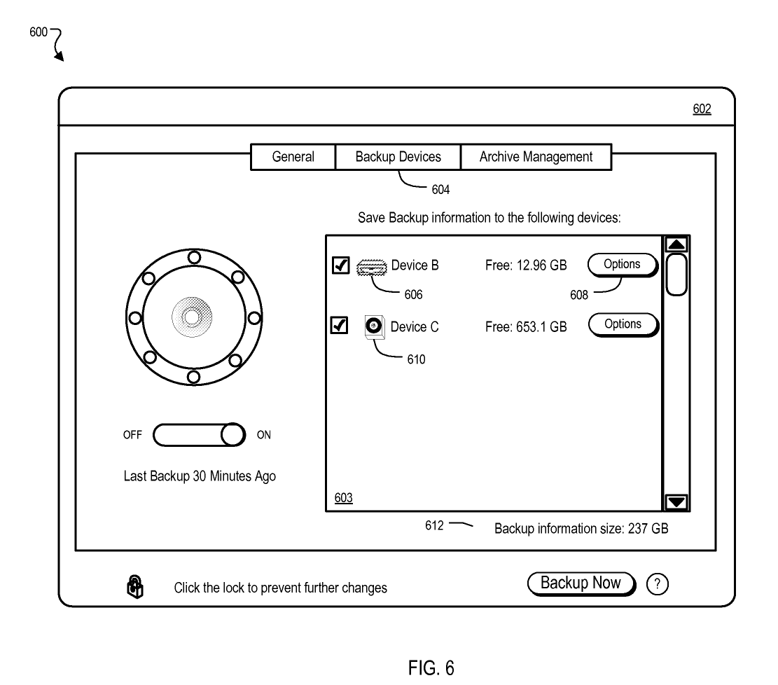

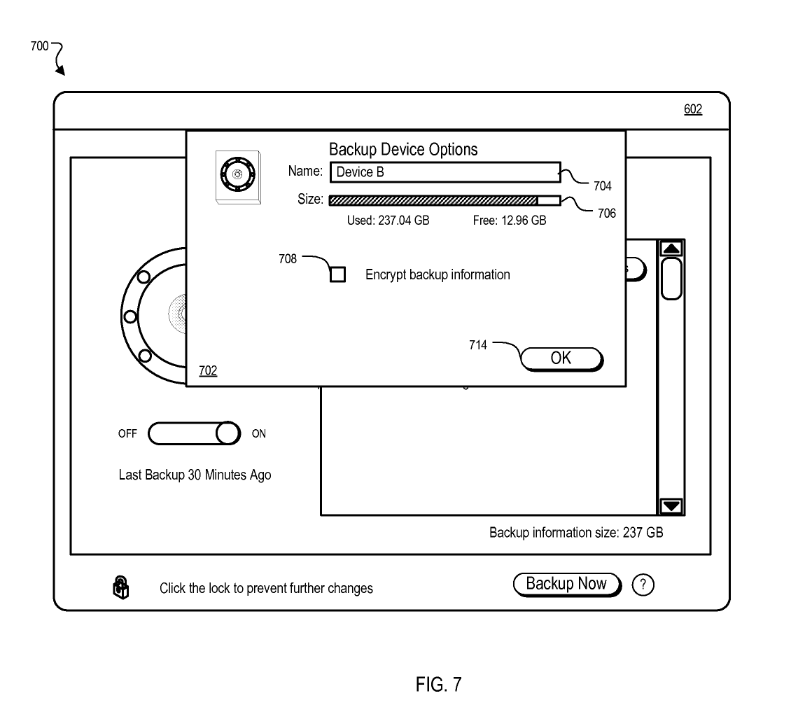

FIG. 6 is a screen shot 600 of an exemplary settings dialog 602 in which a backup devices tab 604 is selected. A backup devices view 603 allows the user to select one or more repositories for storing archived items. In the example shown, a first device 606 and a second device 610 are available for use. A user can select an options button 608 associated with the first device 606 to view a settings dialog for this device. In some implementations, selection of the options button 608 triggers the display of the pop-up window shown in FIG. 7. Icons associated with the first device 606 and the second device 610 can be indicative of the type of the device. For example, the icon associated with the first device 606 is a graphic of an optical device (e.g., a recordable CD drive). The available storage capacities of the devices B and C can be displayed next to their respective icons. An information field 612 informs the user of the present size of the backup information. In the example shown, the backup information distributed between the first device 606 and the second device 610 consumes 237 gigabytes of storage.

### Backup Device Tab—Backup Device Options

FIG. 7 is a screen shot 700 of an exemplary settings dialog 602 in which a backup options button 608 has been selected. In the example shown, a user has selected the options button 608 in the settings dialog 602 (FIG. 6). As shown in FIG. 7, a screen shot 700 contains a pop-up window 702 overlaying the backup devices view 603. The pop-up window 702 displays options relating to the first device 606. An information field 704 contains the storage device name, in this example “Device B”. A bar graph 706 illustrates the amount of free space available on the first device 606. In the example shown, 237.04 gigabytes of memory has been used, and 12.96 gigabytes of memory is free on the first device 606.

A user can select a checkbox 708 to have the corresponding backup information encrypted. For example, in one implementation, this causes the existing archives within the associated backup device to be placed in an encrypted format. In another implementation, only the archives generated after the time of selecting the checkbox 708 will be generated in an encrypted format. In some implementations, the backup capture engine 420 (FIG. 4) creates the encrypted copies for the archives.

In some implementations, the information field 704 can be user-editable to define a storage location in greater detail. For example, a particular segment or segments of a backup device could be selected rather than the entire device. A user can select an OK button 714 to close the popup window 702 and return to the settings dialog 602.

In some implementations, a storage device can be network based, such as storage devices B-D shown in FIG. 1. For example, a user can store backup data on one or more archiving devices using a synchronization technology. Alternatively, an online, offsite data backup service 104 can be used to store backup data. In some implementations, the archiving devices can be the primary storage location for backup data, and the data backup service 104 can be an alternative or secondary storage location for backup data. For example, if the user's primary storage location is not available (e.g., personal network is down), then the backup data can be stored on a server hosted by the data backup service 104.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications may be made to the disclosed implementations and still be within the scope of the following claims.

What is claimed is:

1. A method comprising:
detecting a number of devices in a network that can store at least a portion of a data archive;
determining data to be archived on the device based on a data archive policy that takes into account data value; and
initiating archiving of at least a portion of the data on one or more devices in the network based on the data archive policy.

2. The method of claim 1, further comprising:
authenticating the devices before archiving data on the devices.

3. The method of claim 1, further comprising:
determining if the devices are authorized to receive data archives.

4. The method of claim 1, wherein archiving data further comprises encrypting the data prior to archiving the data.

5. The method of claim 1, wherein the value of the data is specified by a user.

6. The method of claim 1, wherein the value of the data is determined automatically based on activity associated with the data.

7. The method of claim 1, wherein determining data to be archived on the devices further comprises:
determining a combined unused storage capacity of the devices in the network.

8. The method of claim 1, wherein the network is a wireless network.

9. The method of claim 1, wherein archiving data further comprises:
generating a database of information associated with the data archive; and
storing a copy of the database on at least one of the devices in the network.

10. The method of claim 1, wherein archiving data further comprises synchronizing data stored on two or more devices.

11. The method of claim 1, wherein determining data to be archived on the devices further comprises:
determining the combined unused storage capacity of the devices;
prioritizing the data to be archived; and
if the combined unused storage capacity is insufficient for storing all the data to be archived,
archiving a portion of the data on one or more devices in the network based on results of the prioritization.

12. The method of claim 1, wherein the data value is determined automatically based on timestamps associated with the data or whether the data can be restored from sources other than devices in the network.

13. The method of claim 1, wherein the data to be archived includes digital images and the value of the digital images is determined automatically based on frequency of occurrence of the digital images in photo albums.

14. The method of claim 13, wherein a digital image is archived at an image resolution based on the value of the digital image.

15. The method of claim 1, wherein the data is stored redundantly across a number of devices in the network.

16. The method of claim 1, further comprising:
determining if a device has been disconnected from the network for a threshold time;
if a device has been disconnected for the threshold time,
revoking the device as a candidate for receiving data; and
redistributing data stored on the revoked device to one or more other devices in the network.

17. The method of claim 1, wherein at least one device can both create data and archive data.

18. The method of claim 1, wherein at least one device can store data from more than one other device.

19. A method comprising:
initiating restoration of archived data;
detecting a first device on a network;
determining from the first device a number of additional devices in the network that are storing archived data;
establishing connectivity with at least one additional device, if such connectivity is not already established; and
restoring at least a portion of the archived data from data stored on the at least one additional device.

20. A system comprising:
a processor; and
a computer-readable medium operable for coupling to the processor and having instructions stored thereon, which, when executed by the processor, causes the processor to perform operations comprising:
detecting a number of devices on a network that can receive at least a portion of a data archive;
determining data to be archived on the devices based on a data archive policy that takes into account data value; and
initiating archiving of at least a portion of the data on one or more devices based on the data archive policy.

21. The system of claim 20, wherein determining data to be archived on the devices further comprises:
determining the combined unused storage capacity of the devices;
prioritizing the data to be archived; and
if the combined unused storage capacity is in sufficient for storing all the data to be archived,
archiving a portion of the data on one or more devices in the network based on results of the prioritization.

22. The system of claim 20, wherein the data value is determined automatically based on timestamps associated with the data or whether the data can be restored from sources other than devices in the network.

23. The system of claim 20, wherein the data to be archived includes digital images and the value of the digital images is determined automatically based on frequency of occurrence of the digital images in photo albums.

24. The system of claim 20, further comprising:
determining if a device has been disconnected from the network for a threshold time;
if a device has been disconnected for the threshold time,
revoking the device as a candidate for receiving data; and
redistributing data stored on the revoked device to one or more other devices in the network.

25. A system comprising:
a processor; and
a computer-readable medium operable for coupling to the processor and having instructions stored thereon, which, when executed by the processor, causes the processor to perform operations comprising:
initiating restoration of archived data;
detecting a first archiving device on a network;
determining from the first archiving device a number of additional archiving devices in the network that are storing archived data;
establishing connectivity with at least one additional archiving device, if the connectivity is not already established; and
restoring at least a portion of the archived data from data stored on the at least one additional archiving device.
